(19) United States
(12) Patent Application Publication
(10) Pub. No.: US 2009/0220787 A1
(43) Pub. Date: Sep. 3, 2009

(54) SINTERED ALUMINA PRODUCT THAT IS TRANSPARENT TO INFRARED RADIATION

(75) Inventors: Guillaume Bernard-Granger, Mazan (FR); Christophe Sinet, Sorgues (FR)

Correspondence Address: YOUNG & THOMPSON, 209 Madison Street, Suite 500, ALEXANDRIA, VA, 22314, US

(73) Assignee: SAINT-GOBAIN CENTRE DE RECHERCHE ET D'ETUDES EUROPEAN, COURSEVOIE (FR)

(21) Appl. No.: 11/915,416

(22) PCT Filed: May 19, 2006
(86) PCT No.: PCT/FR2006/001153

§ 371 Date: Jun. 11, 2008

(30) Foreign Application Priority Data
May 26, 2005 (FR) 0505308

(51) Int. Cl. C04B 35/101; C04B 35/64

(52) U.S. Cl. 428/402; 264/651

(57) ABSTRACT

A sintered alumina product includes, as a percentage by weight, more than 99.95% of alumina (Al₂O₃), the grain size of the alumina being in the range 0.2 μm to 1.5 μm, and has a density greater than 99.95% of the theoretical density of the alumina.

The present invention relates both to a novel product that is strong and transparent to infrared radiation, in particular to fabricate furnace observation windows or missile domes, and also to a method of producing said product.

Known materials that are transparent in the infrared include polycrystalline magnesium fluoride. That material, however, cannot be used in many applications because of its mediocre mechanical properties (static mechanical properties, rain erosion, abrasion resistance).

Sapphire, which is a monocrystalline material, is also known and offers both transparency in the infrared and good mechanical properties. However, its cost is prohibitive.

Further, International patent application WO2004/007398 proposes polycrystalline alumina comprising zirconium oxide. That material is described as being transparent in the visible region.

The presence of oxides other than alumina may be a problem with certain applications. It also incurs extra cost due to a more complex fabrication method.

Further, research into materials that are strong and transparent to infrared radiation is highly specific. In particular, it is distinctly separate from that relating to materials that are transparent in the visible region. A material that is transparent in a given wavelength range (for example in the visible region) is not necessarily transparent in another range. There is thus nothing to suggest that the material described in WO2004/007398 could be of interest in transmitting infrared radiation.

European patent application EP-A-1 053 983 describes polycrystalline ceramics based on alumina having crystalline particles with a size in the range 0.3 μm [micrometer] to 0.7 μm. The green parts of the products described in EP-A-1 053 983 are obtained by atomization and pressing. The inventors of the present invention have shown that such a method cannot produce a density greater than 99.95% of the theoretical density of alumina. The inventors also consider that the transparency to infrared radiation of the products described in EP-A-1 053 983 is limited.

It should be observed that while EP-A-1 053 983 describes products having a theoretical density of 100.0%, that density was measured using the conventional water buoyancy (Archimedes) method in accordance with standard JIS R 1634, the measurements being rounded off in accordance with standard JIS Z 8401. Taking account of errors in the measurements and in the rounding applied to those measurements, a measured density of 100% does not mean that the density is effectively over 99.95%.

United States patent US-2003/0125189 describes a sintered alumina product obtained from an alumina powder with a purity greater than 99.99%. That product, which is actually intended for dental applications, has wet transmittance, i.e. it is measured under favorable conditions. Further, the measuring device used, in particular the illumination, cannot measure the real in-line transmittance but only a total transmittance, a sum of the real in-line transmittance (RIT) and the diffuse transmittance. The total transmittance measurements are thus always greater than or equal to the RIT measurements regardless of the wavelength under consideration. The three-point bending strength is also lower than that of the products of the present invention. Finally, the density measurements described are imprecise and cannot justify a density greater than 99.95%.

Thus, there is a permanent need for a strong material that is transparent in the infrared, at a reduced cost.

According to the invention, this need is satisfied using a sintered alumina product comprising, as a percentage by weight, more than 99.95% of alpha alumina (Al₂O₃), the grain size of the alumina being in the range 0.2 μm to 1.5 μm, and having a density greater than 99.95% of the theoretical density of the alumina (3.976 grams per cubic centimeter).

As illustrated by the figures and examples below, the product of the invention advantageously has high mechanical strength and very good transparency to infrared radiation.

Preferably, the grain size of the alumina is more than 0.3 μm, more preferably more than 0.45 μm and/or less than 1.0 μm, still more preferably less than 0.75 μm.

Preferably, the microstructure of the product of the invention has a coarse grain surface density Fv, i.e. having a diameter greater than twice the mean diameter of the other grains, of less than 4% of the surface area, preferably less than 2% of the surface area. Preferably, the product of the invention does not include grains having a diameter greater than twice the mean diameter of the other grains.

In the description below, these grains are qualified as “coarse grains”.

The method used to measure the coarse grain surface density (Fv) is described in the description below.

Advantageously, this feature provides the product with transparency to infrared radiation and remarkable mechanical performance, particularly in bending.

Preferably, the product of the invention thus has a three-point bending strength at 20° C. greater than 650 MPa [megapascals], preferably more than 750 MPa. The method used to measure this three-point bending strength is described in the description below.

Preferably, the product of the invention thus has a real in-line transmittance, measured for a sample with a thickness of 1 mm, greater than 75%, more preferably more than 80% for incident radiation wavelengths in the range 2.5 μm to 4.5 μm.

As is discussed in detail in the description below, a density greater than 99.95% of the theoretical density of the alumina may be obtained by carrying out a fabrication method of the invention comprising the following steps in succession:

a) preparing a slip from an alumina powder with a size (mean diameter, measured by X ray sedigraphy and/or X ray diffraction) of elementary particles is in the range 0.02 μm to 0.5 μm;

b) casting the slip into a porous mold then drying and unmolding to obtain a green part;

c) drying the unmolded green part;

d) debinding at a temperature in the range 350° C. to 500° C.;

e) sintering at a temperature in the range 1100° C. to 1350° C. until a sintered product is obtained with a density of at least 92% of the theoretical density of the alumina, i.e. at least 3.658 g/cm³ [grams per cubic centimeter]; and

f) carrying out hot isostatic pressing, “HIP”, at a temperature in the range 950° C. to 1300° C. at a pressure in the range 1000 to 3000 bars.

Debinding and sintering may be carried out in an atmosphere other than air. In contrast, for safety reasons, hot isostatic pressing is preferably carried out in a neutral atmosphere, preferably in argon.

The inventors have discovered that casting a slip can produce a product with a density greater than 99.95% of the theoretical density of the alumina and that this very high density improves transparency to infrared radiation.

Preferably, the method of the invention includes one or more of the following optional features:

the aggregates in the slip are constituted by elementary grains having a mean diameter in the range 0.15 μm to 0.25 μm, preferably of 0.2 μm;

the mold is dried prior to casting the slip;

the temperature during the whole of step b) is in the range 20° C. to 25° C.;

the pressure of the slip inside the mold is in the range 1 bar to 1.5 bar;

the moisture content of the environment of the mold is maintained at between 45% and 55%, preferably between 48% and 52%, for the whole of step b);

hot isostatic pressing is carried out at a temperature below the sintering temperature; preferably, the hot isostatic pressing temperature is 20° C. to 100° C. lower than the sintering temperature;

the inventors have discovered that the fact of carrying out hot isostatic pressing at a temperature below the sintering temperature reduces the coarse grain surface density Fv. This feature means that the surface microstructure of the product of the invention may include less than 4% of coarse grains (Fv) and even include substantially no coarse grains. This results in an improved real in-line transmittance and remarkable bending strength;

preferably, in step a), dispersion of the alumina powder grains in the slip is improved using beads. Preferably again, the amount of alumina in said beads, also termed “grinding beads”, is over 99.5% by volume This feature limits the number of coarse grains and thus further improves the real in-line transmittance and the bending strength of the product obtained. Said beads are removed from the slip before shaping the slip.

The invention also provides the use of a product obtained by a method of the invention, or more generally a product of the invention, as a furnace observation window or a missile dome. The remarkable real in-line transmittance and the bending strength of the product of the invention render it particularly suitable for those applications.

Finally, the invention provides a method of preparing a slip comprising an alumina powder in suspension in a liquid, beads being caused to move within said liquid to facilitate said suspension. This method is remarkable in that the amount of alumina in said beads is greater than 99.5% by volume.

Preferably, said method is carried out in the context of step a) of a fabrication method of the invention, to produce a sintered alumina product in accordance with the invention. Advantageously, this results in a limited number of coarse grains in the product obtained.

Other characteristics and advantages of the invention become apparent from the following description and from a study of the accompanying drawings in which:

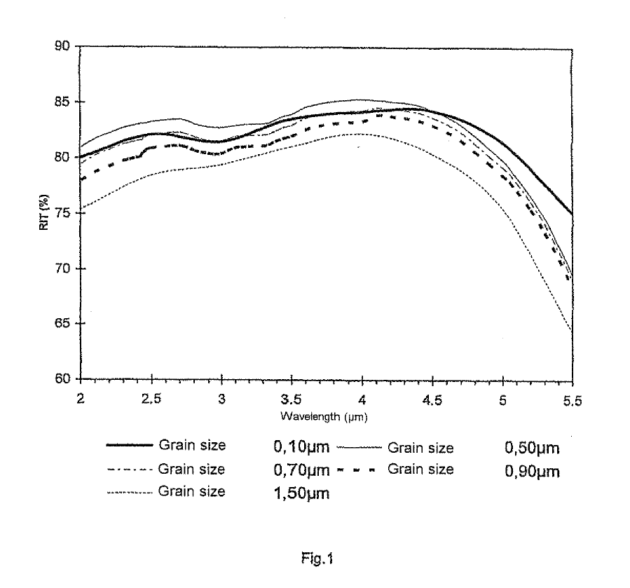

FIG. 1 plots graphs showing the real in-line transmittance (RIT) measurements of various products as a function of the wavelength of incident radiation;

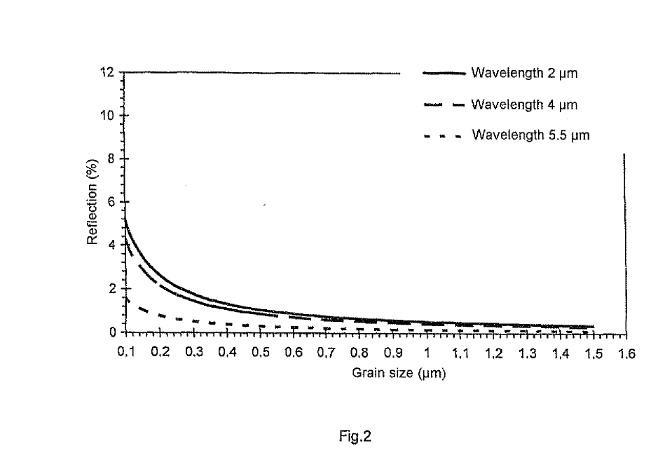

FIG. 2 plots graphs showing calculations of the reflectance of various products as a function of grain size for different values of the wavelength of incident radiation; and

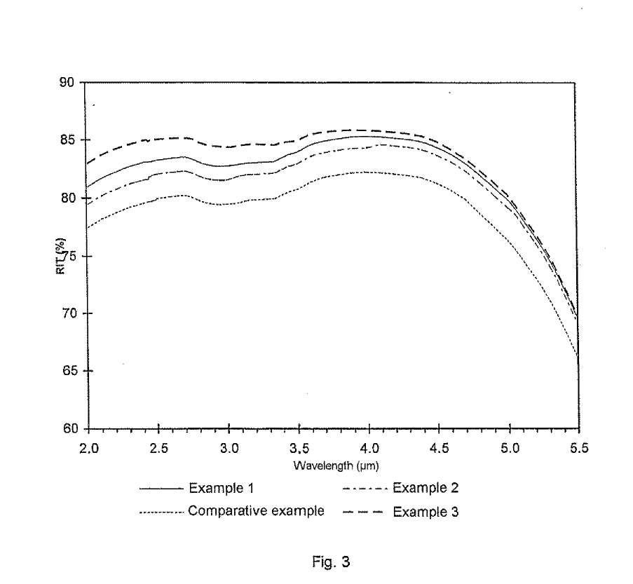

FIG. 3 plots graphs showing the real in-line transmittance (RIT) measurements of the products featured in the examples below as a function of the wavelength of incident radiation.

In step a) of the fabrication method of the invention, a slip is prepared from an alumina powder.

The term “slip” is used to describe a substance formed by a suspension of particles in a liquid, generally water or an organic solvent (for example alcohol) with or without additives such as dispersing agents, deflocculating agents, polymers, etc. Preferably, the slip comprises a temporary binder, i.e. a binder which is eliminated from the product during sintering.

In particular, an “alumina slip” is a slip constituted by a suspension of an alumina powder. Unless otherwise indicated, the term “slip” is employed in this document to designate an alumina slip.

The purity of the alumina powder is determined in a manner which is known per se so that the final sintered alumina product obtained by the method of the invention comprises more than 99.95% of Al₂O₃ as a percentage by weight. Typically, the powder used has a purity greater than 99.97% by volume.

Similarly, the size of the alumina grains in the final product depends, in known manner, on the size of the particles of alumina powder used in step a). In order for the size of the grains in the final product to be in the range 0.2 μm to 1.5 μm, the particle size (mean diameter) of the powder used is chosen to be between 0.02 μm and 0.5 μm.

Preferably, the particle size of the powder used is chosen so that the size of the alumina grains in the final product is more than 0.3 μm, more preferably more than 0.45 μm and/or less than 1.0 μm, preferably again less than 0.75 μm.

The slip may be produced in a receptacle using techniques which are known to the skilled person by mixing and homogenizing alumina powder and the desired quantity of liquid.

Preferably, the slip includes more than 60% dry matter.

Preferably again, the receptacle containing the slip may temporarily be subjected to an underpressure, preferably greater than 0.5 bar, to eliminate as many residual air bubbles as possible from the slip.

Preferably, the mold is pre-dried. Advantageously, the setting time during drying step b) is reduced.

The temperature during the preform casting and formation operations is preferably maintained at between 20√ C. and 25° C.

After filling the mold, at least one porous wall of the mold absorbs at least part of the liquid from the slip. Complete filling of the mold and evacuation may be encouraged by placing the interior of the mold under pressure, for example using a gravity feed which is adapted to the geometry of the part. Preferably, the pressure of the slip in the mold interior is in the range 1 bar to 1.5 bar. Advantageously, the density of the green part is increased thereby and/or makes it possible to form parts with a thickness greater than 3 millimeters.

Preferably again, the moisture content of the air surrounding the mold is maintained at between 45% and 55%, preferably between 48% and 52%, for the whole of step b). Advantageously, the drying time is controlled thereby.

As the liquid is evacuated, the alumina particles become immobilized relative to each other. This immobilization is termed “setting” of the preform. The residual porosity between the immobilized particles allows the liquid to pass through, however.

Additional slip is preferably introduced into the mold as the liquid is absorbed. Advantageously, part of the volume left vacant by the liquid is thereby filled by alumina particles from the additional slip.

After the moisture content of the part in the mold has fallen below 2%, it is considered to have undergone sufficient drying to ensure its integrity and to maintain its geometry during handling after unmolding. The mold then contains a “preform” and the supply of additional slip is ceased. The preform is then unmolded to obtain a green part.

In step c), the green part undergoes additional drying, for example by storing in an oven with a controlled temperature and moisture content, in accordance with conventional techniques.

In step d), the dried green part undergoes debinding, preferably in air, at a temperature in the range 350° C. to 500° C. Debinding is an operation which is known per se and intended to eliminate organic products from the green part.

In step e), the dried and debound green part, or “blank”, is sintered, i.e. densified and consolidated by a heat treatment.

Conventionally, the blank is placed in a medium, preferably air, the temperature of which varies as a function of time in accordance with a predetermined cycle. The heat treatment comprises a stage for raising the temperature of the medium surrounding the part, then a stage for maintaining the temperature, or “sintering stage”, at a temperature in the range 1100° C. to 1350° C., and finally a temperature drop stage. Sintering may be carried out in a conventional furnace or by SPS (spark plasma sintering) or by MWS (microwave sintering).

The duration of the sintering stage is preferably in the range 0.25 to 20 hours. In a conventional furnace, the ramp-up/ramp-down temperature rates are in the range 50° C./hour to 150° C./hour. For sintering by SPS or MWS, they are in the range 20° C. to 100° C./minute.

Sintering causes shrinkage, and thus densification of the part. It is possible to obtain a density after sintering of 92% or more of the theoretical density of the alumina. This limit is considered by the skilled person to be necessary to obtain, after the following step f) (HIP), a density greater than 99.95% of the theoretical density of the alumina.

In step f), and after cooling, the sintered part resulting from sintering the blank undergoes post-heat treatment under pressure known as “HIP” (hot isostatic pressing), preferably in a neutral gas (for example argon).

Hot isostatic pressing (HIP) is carried out in a chamber the temperature of which is in the range 950° C. to 1300° C., at a pressure in the range 1000 to 3000 bars. The temperature in the chamber is preferably lower than the sintering temperature. Preferably again, the temperature in the chamber is 20° C. to 100° C. lower than the sintering temperature.

The hot isostatic pressing (HIP) operation can further increase the density of the parts by eliminating residual porosity that may be present after sintering, and can close up certain structural defects (micro-cracks), thereby improving the mechanical behavior of the ceramic parts.

At the end of step f), a sintered alumina product is obtained in accordance with the invention comprising, as percentages by weight, more than 99.95% of alumina (Al₂O₃), the grain size of the alumina being in the range 0.2 μm to 1.5 μm, and having a density greater than 99.95% of the theoretical density of the alumina.

The following non-limiting examples are given with the aim of illustrating the invention.

Samples were prepared in accordance with a method of the invention as follows.

A slip in the form of a suspension with 65% dry matter was prepared by mixing, in a drum grinder, a dispersing agent, an organic binder and alumina powder with a purity greater than 99.97% and with a median aggregate diameter d50 of 10 μm, constituted by elementary grains having a d50 of 0.2 μm. The grinding beads, used to improve the suspension of alumina powder, were formed from 99% by volume alumina (products of examples 1, 2 and comparative example). Preferably, the amount of alumina in the grinding beads was more than 99.5% by volume (product of Example 3).

Advantageously, the method of the invention allows products to be fabricated that are transparent in the infrared without adding a dopant such as magnesium oxide.

Further, the inventors have shown that the transparency to infrared radiation and the mechanical performance of the product of the invention are improved when its surface microstructure has a coarse grain surface density Fv of less than 4% of “coarse grains”, preferably less than 2%. Preferably, said microstructure does not include coarse grains, a coarse grain being a grain with a diameter greater than twice the mean diameter of the other grains (analysis carried out on images obtained by scanning electron microscopy).

The prepared slip was deaerated and cast into a plaster mold which had been in an oven for 48 hours at 50° C. During casting and holding in the mold, the temperature was maintained at 23° C., the ambient air being at atmospheric pressure and having a moisture content of 50%.

After initial drying in the mold, then unmolding, the green part underwent additional drying and debinding in air for 3 hours at 480° C., then was left to stand under ambient temperature and pressure conditions for 2 days.

The blank obtained was then sintered in air at 1250° C. for 3 hours. Finally, the sintered part underwent hot isostatic pressing (HIP).

Infrared radiation may be transmitted, reflected or diffused. Conventionally a material is termed “transparent” to infrared radiation when it is capable of transmitting that radiation in-line, i.e. it has a high transmittance (RIT, real in-line transmittance). For a pure material, when the measured RIT values are close to the theoretical RIT values calculated taking into account the refractive index of the material, diffusion is negligible. A pure material is more “transparent” when it has a higher RIT and a lower reflection.

To determine transparency, the parts were precision ground and polished to a mirror quality. At the end of the preparation, the products had a Ra (average roughness) of <10 nm [nanometer] and a thickness of 1 mm [millimeter]. The RIT was then measured in the infrared wavelength range, i.e. in the range 2 μm to 6 μm.

The reflection was also calculated as a function of grain size for different wavelengths of the infrared.

The grain size was measured using a “mean linear intercept” method based on analyzing images obtained by scanning electron microscopy of breaking patterns. A method of this type is described in the ASTM method (American Linear Intercept Method): NPA 04102. The results obtained by this method were multiplied by a correction coefficient of 1.2 to take the three dimensional aspect into account.

The method used to measure the coarse grain surface density Fv was as follows: A section of the product was polished until a mirror quality polish is obtained. After polishing, thermal attack was carried out at a temperature 50° C. to 80° C. lower than the sintering temperature, for 0.5 hours. A photograph with a total area TA was then taken by scanning electron microscopy. On this photograph, coarse grains were polygonized by image analysis and the total area represented by the coarse grains, CGA, was calculated. The “surface density” of the coarse grains, Fv, is the ratio of the total coarse grain area, CGA, divided by the total area TA, multiplied by 100.

The mechanical strength of the sintered parts of the invention was measured by three-point bending on samples with dimensions of 40 mm×4 mm×3 mm, with a distance between the points of 20 mm and a crossbeam speed of 0.5 mm/minute.

The graphs of FIG. 1 show that a RIT of 70% or more requires a grain size of less than 1.5 μm. Preferably, the RIT is 80% or more between 2.5 μm and 5 μm, which corresponds to products with a grain size of less than 1 μm.

The graphs of FIG. 2 show that if the grain size is less than 0.2 μm, reflection is no longer negligible. Thus, transparency in the infrared is reduced. Surprisingly, a lower limit of 0.2 μm must therefore be imposed to optimize transparency. This is in contrast to EP-A-1 053 983 which teaches that the transparency of the material would be improved by reducing the grain size to less than 0.3 μm.

Table 1 below provides the results of the measurement tests, especially the 3-point bending strength.

TABLE 1

| Examples | 1 | 2 | 3 | Comparative |
|---|---|---|---|---|
| Grain size (μm) | 0.50 | 0.70 | 0.55 | 0.5 |
| Sintering | 1250 | 1250 | 1250 | 1250 |
| temperature | | | | |
| HIP temperature | 1200 | 1200 | 1200 | 1275 |
| HIP temp < sintering | Yes | Yes | Yes | No |
| temp? | | | | |
| Coarse grain surface | <4% | <4% | 0 | 7 |
| density | | | | |
| 3-point bending, | 698 | 612 | 815 | 430 |
| 20° C. (MPa) | | | | |

It appears that the bending strength of the sintered products of the invention is highly satisfactory. In particular, it is higher than that of the products described in United States patent US-2003/0125189 (620 MPa at 20° C.).

The graphs of FIG. 3 show that product 3, which is most preferred, exhibits maximum RIT values.

As is clear from the present document, the invention thus provides a very dense, very homogeneous product which only slightly perturbs the passage of infrared radiation. Advantageously, this product, which is strong and transparent in the infrared, is cheap.

Clearly, the present invention is not limited to the implementations described which are provided by way of non-limiting illustrative examples.

1-14. (canceled)

15. A sintered alumina product comprising, as a percentage by weight, more than 99.9S% of alumina (Al₂O₃), the grain size of the alumina being in the range 0.2 μm to 1.5 μm, and having a density greater than 99.95% of the theoretical density of the alumina.

16. A product according to claim 15, wherein the grain size of the alumina is over 0.3 μm.

17. A product according to claim 15, wherein the grain size of the alumina is less than 1.0 μm.

18. A product according to claim 15, wherein the grain size of the alumina is over 0.3 μm and less than 1.0 μm.

19. A product according to claim 15, wherein the grain size of the alumina is over 0.45 μm.

20. A product according to claim 15, wherein the grain size of the alumina is less than 0.75 μm.

21. A product according to claim 15, wherein the grain size of the alumina is over 0.45 μm and less than 0.75 μm.

22. A product according to claim 15, comprising a surface density (Fv) of grains with a diameter greater than twice the mean diameter of the other grains of less than 4% of the surface area.

23. A product according to claim 18, comprising a surface density (Fv) of grains with a diameter greater than twice the mean diameter of the other grains of less than 4% of the surface area.

24. A product according to claim 21, comprising a surface density (Fv) of grains with a diameter greater than twice the mean diameter of the other grains of less than 4% of the surface area.

25. A product according to claim 22, containing no grains with a diameter greater than twice the mean diameter of the other grains.

26. A product according to claim 23, containing no grains with a diameter greater than twice the mean diameter of the other grains.

27. A product according to claim 24, containing no grains with a diameter greater than twice the mean diameter of the other grains.

28. A product according to claim 15, having a three-point bending strength at 20° C. greater than 650 MPa.

29. A product according to claim 15, having a real in-line transmittance (RIT) greater than 80% for wavelengths of incident radiation in the range 2.5 μm to 4.5 μm.

30. A method of fabricating a sintered alumina product comprising the following steps in succession:
a) preparing a slip from an alumina powder with an elementary particle size in the range 0.02 μm to 0.5 μm;
b) casting the slip into a porous mold then drying and unmolding to obtain a green part;
c) drying the unmolded green part;
d) debinding at a temperature in the range 350° C. to 500° C.;
e) sintering at a temperature in the range 1100° C. to 1350° C. until a sintered product is obtained with a density of at least 92% of the theoretical density of the alumina; and
f) carrying out hot isostatic pressing, “HIP”, at a temperature in the range 950° C. to 1300° C. at a pressure in the range 1000 to 3000 bars.

31. A method of fabricating a sintered alumina product according to claim 30, in which the mold is dried prior to casting the slip.

32. A method of fabricating a sintered alumina product according to claim 30, in which the temperature is in the range 20° C. to 25° C. during the whole of step b).

33. A method of fabricating a sintered alumina product according to claim 30, in which the pressure of the slip inside the mold is in the range 1 bar to 1.5 bar.

34. A method of fabricating a sintered alumina product according to claim 30, in which the moisture content of the environment of the mold is maintained at between 45% and 55% for the whole of step b).

35. A method of fabricating a sintered alumina product according to claim 30, in which the hot isostatic pressing is carried out at a temperature below the sintering temperature.

36. A method according to the claim 35, in which the hot isostatic pressing temperature is 20° C. to 100° C. lower than the sintering temperature.

37. A furnace observation window or a missile dome comprising the sintered alumina product of claim 15.

38. A method of fabricating a sintered alumina product according to claim 30, wherein, in step a), dispersion of the alumina powder grains in the slip is improved using beads.

39. A method of fabricating a sintered alumina product according to claim 38, wherein the amount of alumina in said beads is over 99.5% by volume.
